(19) United States
(12) Patent Application Publication
(10) Pub. No.: US 2017/0055135 A1
(43) Pub. Date: Feb. 23, 2017

(54) TWO WAY MODULAR RADIO APPARATUS

(71) Applicants: Robert Jimenez, Elmwood Park, NJ (US); Hermes Jimenez, JR., Elmwood Park, NJ (US)

(72) Inventors: Robert Jimenez, Elmwood Park, NJ (US); Hermes Jimenez, JR., Elmwood Park, NJ (US)

(21) Appl. No.: 15/236,964

(22) Filed: Aug. 15, 2016

Related U.S. Application Data
(60) Provisional application No. 62/207,003, filed on Aug. 19, 2015.

(51) Int. Cl. H04W 4/10; H04M 1/02; H04W 4/02; H04B 1/3827

(52) U.S. Cl. CPC H04W 4/10; H04B 1/3827; H04M 1/026; H04W 4/02; H04W 84/12

(57) ABSTRACT

A two way modular radio apparatus capable of integrating with smart devices to enable users of the smart devices to communicate with a plurality of other smart device users through a common radio frequency without the use of the internet or other cellular connections. The modular radio is comprised of a housing integrated with a radio frequency (RF) transceiver, a control processor for processing the radio signals from the RF transceiver, a switch for switching between the RF transceiver and other radio cards integrated with the smart device and a plurality of anchor units for electronically coupling the RF transceiver, control processor and the switch with the electronic components of the smart device. A push to talk button on the apparatus enables a user to transmit their voice communication to another user and an antenna attached to the apparatus amplifies the voice communications transmitted and received.

### CROSS REFERENCE TO RELATED APPLICATION

This application claims priority under 35 USC 119(e) to U.S. Provisional Patent Application Ser. No. 62/207,003 filed on Aug. 19, 2015, which is incorporated herein by reference, in its entirety.

### FIELD OF THE INVENTION

The present invention generally relates to a communication system. More particularly, the invention relates to a two way modular radio apparatus utilizing the Digital Mobile Radio (DMR) standard and the Time Division Multiple Access (TDMA) method for radio communication between users.

### BACKGROUND OF THE INVENTION

In the old days, two way radio systems were predominately comprised of bulky handheld walkie talkies mainly, used by soldiers during war time and law enforcement entities. These systems were capable of operating only in a simplex or a half-duplex push to talk mode and generally depended on the hardware that was initially installed within the devices and therefore not capable of being upgraded. These modes of two way radio communications have in recent times been replaced by full duplex mode radio communications using hand held phones and more popularly, mobile smart phones.

Although the duplex mode radio communications in mobile phones allow the user to listen and talk simultaneously, without a multiple access feature such as the Time Division Multiple Access (TDMA) method, multiple users may not be able to share the same radio frequency transmission medium while communicating with each other. A Digital Mobile Radio (DMR) is an open digital radio standard and is a two slot TDMA system offering voice, data and other applications that makes it possible for multiple users to share the same radio frequency transmission medium to communicate with each other.

The present invention is a two way modular radio apparatus that uses the features of the DMR, the TDMA and Analog systems which allow the user of the apparatus to transform their smart phone or tablet into their own unique off the grid peer to peer network, to connect with friends and family.

The exemplary features of the two way modular radio apparatus of the present invention will become obvious to one skilled in the art through the summary of the invention, detailed description of the invention, and the claims that follow.

### SUMMARY OF THE INVENTION

The present invention is a two way modular radio apparatus which uses the Digital Mobile Radio (DMR) standard and the Time Division Multiple Access (TDMA) and Analog methods to connect multiple users of smart phones and other smart devices so that they can communicate with each other through the same radio frequency without the use of an internet or cellular connection.

In an exemplary embodiment of the present invention, an anchor mechanism integrated with the housing of the modular radio allows it to be coupled electronically to a smart phone through a modular case holding the phone. In this embodiment of the invention, the modular case holding the phone provides a docking space to link the components of the two way modular radio apparatus to the electronic components of the smart phone.

In the exemplary embodiment of the two way radio module apparatus of the invention, once the module of the invention is docked and coupled to the electronic components of the smart phone, users of the phone are able to communicate with their selected group of friends and family through voice and text messages over the same radio frequency without the need for an internet or other cellular connection.

In yet other embodiments of the two way modular radio apparatus of the invention, the module can be upgraded with additional features such as Very High Frequency (VHF), Ultra High Frequency (UHF) radio spectrums, encryption etc,. Also, modules with dual and multi-bands can be added according to the needs of the user.

Embodiments of the two way modular radio apparatus of the present invention allow users to create their own private network through privacy channels. The intelligent software incorporated within the apparatus automatically detects other users of the radio system that are within the frequency range and makes it possible to tune into their channels. The software within the apparatus also allows the user to switch from the walkie talkie mode to an Internet push to talk mode when out of range of the radio frequency network. Further, a wireless fidelity (wifi) only operation mode allows the user to use the apparatus as a wifi two way radio. Global Positioning System (GPS) tracking and SOS beacon operations are also features of the embodiments of the invention. Through specific applications (Apps) for the modular radio of the present invention, the system can be programmed and managed via cloud-based solutions which is ideal for mass deployments.

The foregoing summary of the present invention and its embodiments should not be construed to limit the scope of the invention. In this summary of the invention and in the specification in general references to the embodiments of the invention as, “the exemplary embodiment,” “yet another embodiment” and all such related references to embodiments of the invention do not necessarily refer to the same embodiment (s). Rather, these references to the various embodiments in general mean that a particular feature, structure, or characteristic described in conjunction with an embodiment is included in at least some embodiments, but not necessarily all embodiments of the invention. The objects, embodiments, and features of the present invention as described in this summary of the invention will be further appreciated and will become obvious to one skilled in the art when viewed in conjunction with the accompanying drawings, detailed description of the invention, and the appended claims.

### BRIEF DESCRIPTION OF THE DRAWINGS

FIG. 1 is a perspective view of the two way modular radio apparatus of the present invention.

FIG. 2 is a bottom plan view of the two way modular radio apparatus of the present invention.

FIG. 3 is a side view of the two way modular radio apparatus of the present invention.

FIG. 4 is another side view of the two way modular radio apparatus of the present invention.

FIG. 5 is a top plan view of the two way modular radio apparatus of the present invention.

### DETAILED DESCRIPTION OF THE INVENTION

The present invention of a two way modular radio apparatus uses the Digital Mobile Radio (DMR) standard and the Time Division Multiple Access (TDMA) and Analog methods to convert smart phones and other smart devices into modern day walkie talkies that allows users to communicate with each other without the use of an internet or other cellular connections. The apparatus of the invention makes it possible for multiple users to share the same radio frequency transmission medium to communicate with each other.

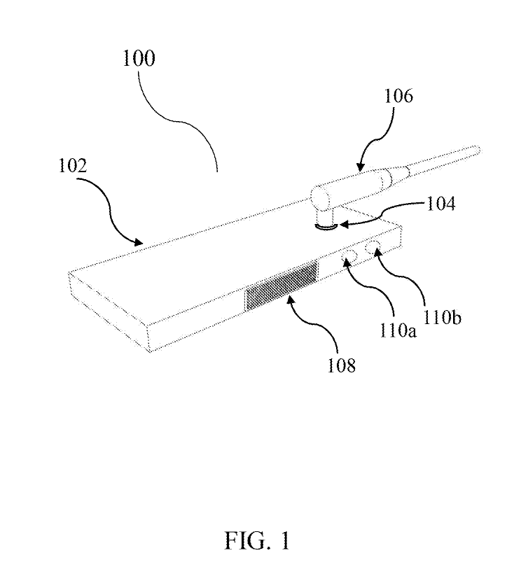

Referring now to the drawings, particularly to FIG. 1 this figure is a perspective view of the exemplary embodiment of the two way modular radio apparatus 100 of the present invention. The two way modular radio apparatus 100 is comprised of a housing 102 which holds the essential elements of the apparatus 100 for its functioning when connected to a smart phone or other smart device. On the top surface of the housing 102 at one end is an antenna port 104 to receive the stem of an antenna 106 and hold the antenna 106 in place on the housing 102. The function of the antenna 106 is to amplify communication signals between devices. On the outer end of one side of the housing 102 is a push to talk control button 108, an audio in jack 110a and an audio out jack 110b. The push to talk control button 108 allows a user to transmit voice signals to other smart phones or other smart devices in the hands of a second user or multiple users. The audio in jack 110a and the audio out jack 110b provide the user with the ability to plug in an external audio device such as a speaker or microphone to the two way modular radio apparatus 100.

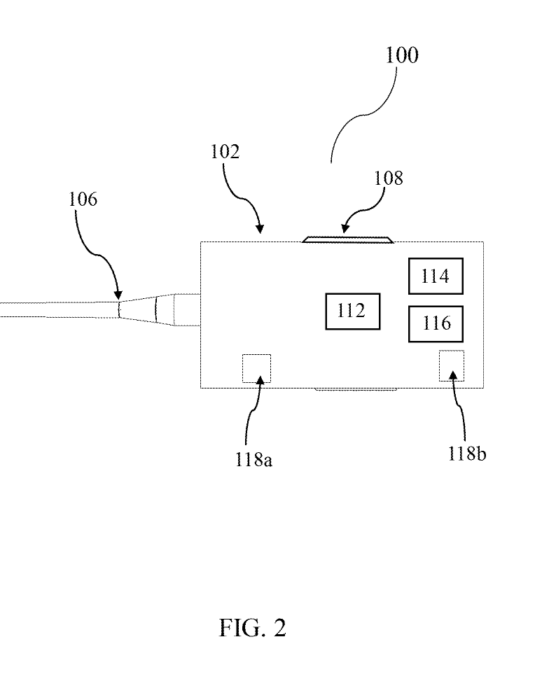

Referring now to FIG. 2 which shows a bottom plan view of the two way modular radio apparatus 100 more particularly, the features configured on the bottom of the housing 102 that are required for interaction with the electronics of the smart phone or other smart device to enable the smart phone or other smart device to convert to a walkie talkie style mode to exchange communications with other smart devices equipped with the apparatus. A control processor 114 on the housing 102 processes the voice signals generated when a user depresses the push to talk control button 108 to start communicating with another user through their smart phone or other smart device. Examples of the control processor 114 include, but are not limited to a micro controller, a single or multicore core processor and/or other similar processors. The two way modular radio apparatus 100 further includes a radio frequency (RF) transceiver 116 coupled to the housing 102 for receiving and transmitting signals between devices. Examples of the RF transceiver 116 include, but are not limited to, very high frequency (VHF) transceivers, ultra-high frequency (UHF) transceivers, Low power Bi-band transceiver, micro wave transceiver, wifi transceiver module, usb wireless transceiver, other long range transceivers etc. A switch 112 configured on the housing 102 functions to switch between the RF transceiver 116 and other radio cards that may be on the smart phone. The housing 102 is further configured with two or more anchor units 118a and 118b to facilitate the electronic coupling of the control processor 114, the RF transceiver 116 and the switch 112 on the two way radio module apparatus 100 to the electronic components of the smart phone or other smart devices.

In another preferred embodiment of the two way modular radio apparatus 100 of the present invention, the control processor 114 receives a command from a central server to control the RF transceiver 116 and the switch 112. In yet another embodiment, the control processor 114 receives a command from the smart phone or other smart device to which the two way modular radio apparatus 100 is docked and the command may be to control the RF transceiver 116.

In the exemplary embodiment of the invention, a Bluetooth integrated circuit is configured within the two way modular radio apparatus 100 of the invention so that the Bluetooth circuit can connect to external devices such as smart phones, tablets, speakers, microphones etc., and receive and send audio from and to the module using the Bluetooth feature.

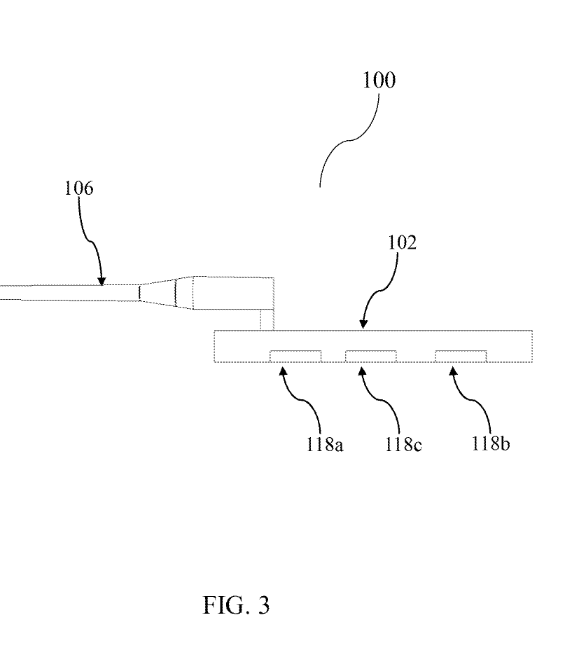

FIG. 3 is a side view of the two way modular radio apparatus illustrating a plurality of the anchor units 118a, 118b and 118c that facilitate the electronic coupling of the two way modular radio apparatus 100 through its housing 102 to the smart phone or other smart devices.

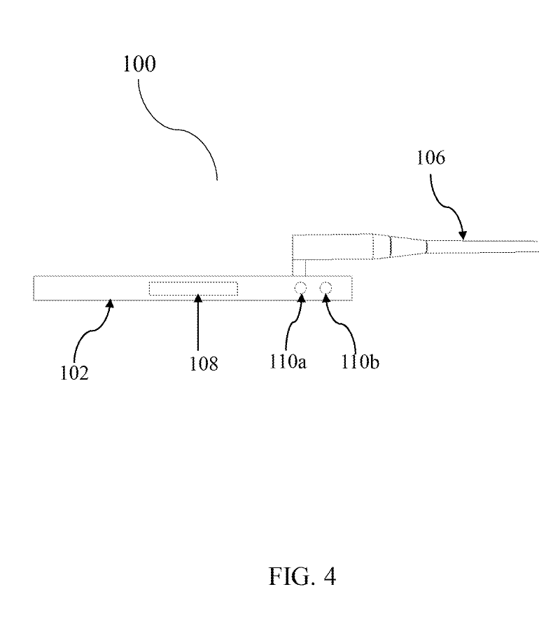

FIG. 4 is a side view of the two way modular radio apparatus 100 illustrating the positioning of the antenna 106 the push to talk control button 108 and the audio in audio out jacks 110a and 110b. The side view of the apparatus 100 shown in this figure is the side of the module that is accessible for the user to be able to depress and release the push to talk control button 108.

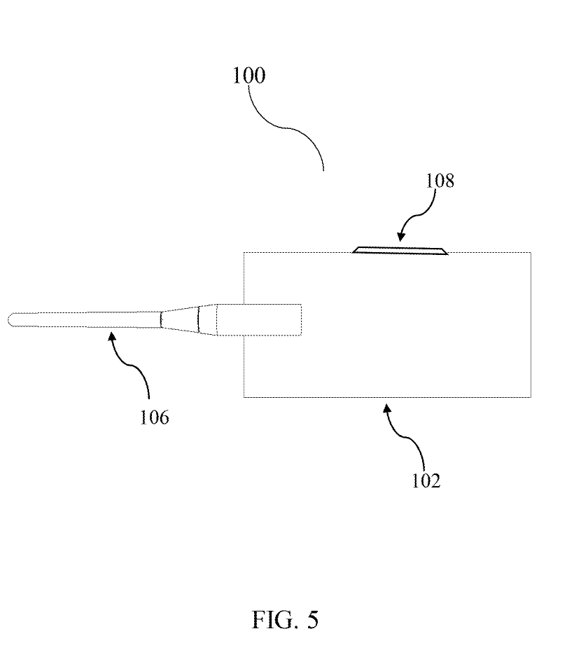

FIG. 5 is a top plan view of the two way modular radio apparatus 100 with the antenna 106 projecting from the housing 102 and a partial view of the push to talk control button 108.

The exemplary embodiment of the present invention of a two way modular radio apparatus thus described through the foregoing figures should not be construed to limit the scope of the invention. It is to be understood that the embodiments of the present invention as described herein do not limit any application or scope of the invention and that the invention can be carried out and practiced in various ways and implemented in embodiments other than the ones outlined in the description above. It should be understood and obvious to one skilled in the art that alternatives, modifications, and variations of the embodiments of the present invention may be construed as being within the spirit and scope of the appended claims.

What is claimed is:

1. A two way modular radio apparatus capable of integrating with smart devices to enable users of said smart devices to communicate with a plurality of other smart device users through a common radio frequency, said apparatus comprising:
a housing;
a radio frequency transceiver integrated with said housing for transmitting and receiving communication signals from a plurality of smart devices;
a control processor integrated with said housing for processing said communication signals from said radio frequency transceiver;
a push to talk button integrated with said housing to enable a user to transmit voice signals to at least one of said other smart device users through their smart devices;
an antenna placed on said housing through an antenna port on said housing;
a switch structure integrated with said housing to enable the switching of transmissions between said radio frequency transceiver and one or more radio cards on said smart device; and
a plurality of anchor units integrated with said housing for electronic coupling of said radio frequency transceiver, said control processor and said switch with a plurality of electronic components on said smart device.

2. The two way modular radio apparatus according to claim 1 wherein said antenna amplifies the communication signals transmitted and received by the radio frequency transceiver.

3. The two way modular radio apparatus according to claim 1 wherein a set of audio in and audio out jacks are integrated with the housing to enable the connecting of external audio devices to the modular radio apparatus.

4. The two way modular radio apparatus according to claim 1 wherein the control processor receives a command from a central server, the command leading to control of the radio frequency transceiver.

5. The two way modular radio apparatus according to claim 1 wherein the control processor receives a command from a central server to control the switch structure for switching transmissions between the radio frequency transceiver and at least one of the plurality of electronic components on the smart device.

6. The two way modular radio apparatus according to claim 1 wherein the control processor receives a command from the smart device to control the radio frequency transceiver.

7. The two way modular radio apparatus according to claim 1 wherein the apparatus automatically detects other users of the radio system that are within the same frequency range and makes it possible for the user to tune into their channels.

8. The two way modular radio apparatus according to claim 1 wherein multiple users share the same radio frequency transmission medium to communicate with each other.

9. The two way modular radio apparatus according to claim 1 wherein the radio module apparatus operates on a plurality of radio frequencies as very high frequency (VHF) and ultra-high frequency (UHF).

10. The two way modular radio apparatus according to claim 1 wherein the software within the apparatus allows a user to switch from the walkie talkie mode to an internet push to talk mode when out of range of the radio frequency network.

11. The two way modular radio apparatus according to claim 1 wherein the apparatus can be switched to a wifi only operation mode allowing the user to use the apparatus as a wifi two way radio.

12. The two way modular radio apparatus according to claim 1 wherein the radio module apparatus is integrated with Bluetooth circuit systems to enable communications with smart devices.

13. The two way modular radio apparatus according to claim 1 wherein GPS tracking and SOS beacon operations can be performed by the apparatus.

14. The two way modular radio apparatus according to claim 1 wherein through specific applications (Apps), the system of the apparatus can be programmed and managed via cloud-based solutions.
